(19) United States
(12) Patent Application Publication
(10) Pub. No.: US 2009/0066675 A1
(43) Pub. Date: Mar. 12, 2009

(54) DISPLAY DRIVER AND DIGITAL TO ANALOG CONVERTER THEREOF

(76) Inventors: Ying-Lieh Chen, Sinshih Township (TW); Chien-Ru Chen, Sinshih Township (TW); Chuan-Che Lee, Sinshih Township (TW)

Correspondence Address: JOHN CHEN, ROOM 303, 3F, NO. 25, SEC. 1, CHANGAN E. ROAD, TAIPEI, 10441, TW

(21) Appl. No.: 11/852,331

(22) Filed: Sep. 10, 2007

(51) Int. Cl. G06F 3/038; G09G 3/36

(52) U.S. Cl. 345/204; 345/87; 345/99

(57) ABSTRACT

The present invention provides a programmable digital to analog converter comprises a reference voltage generator for generating a plurality of reference voltages based on a plurality of reference signals respectively, the gamma reference voltage generator comprising: a resistor string comprising a plurality of resistors in serial for providing a plurality of voltages; and a plurality of reference decoders, each receiving said voltages from said resistor string and selectively outputting a reference voltage from said voltages based on the corresponding reference signal, and a data decoder receiving the reference voltages for selectively outputting an analog voltage based on a data signal.

### BACKGROUND OF THE PRESENT INVENTION

1. Field of Invention

The invention relates to a display driver, and more particularly to a digital-to-analog converter.

2. Description of Related Arts

Referring to the FIG. 4, it illustrates the conventional architecture of a LCD panel, comprising a panel 410, a display driver 420, a gate driver 430, and an X-board 440 with a timing controller and gamma voltage generator for providing gamma reference voltages for the source driver 420.

### SUMMARY OF THE PRESENT INVENTION

An object of the present invention is to simplify the bus lines between the timing controller and the source driver.

Another object of the present invention is to provide a programmable digital to analog converter for an LCD panel.

Accordingly, in order to accomplish the one or some or all above objects, the converter comprises a reference voltage generator for generating a plurality of reference voltages based on a plurality of reference signals respectively, the reference voltage generator comprising: a resistor string comprising a plurality of resistors in serial for providing a plurality of voltages, and a plurality of reference decoders, each receiving said voltages from said resistor string and selectively outputting a reference voltage from said voltages based on the corresponding reference signal, and a data decoder receiving the reference voltages for selectively outputting an analog voltage based on a data signal.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 illustrates an embodiment of a driving system of the present invention.

FIG. 2 illustrates an embodiment of a source driver of the present invention.

FIG. 3 illustrates a block diagram, a digital to analog converter, in accordance with the present invention.

FIG. 4 illustrates a conventional LCD panel.

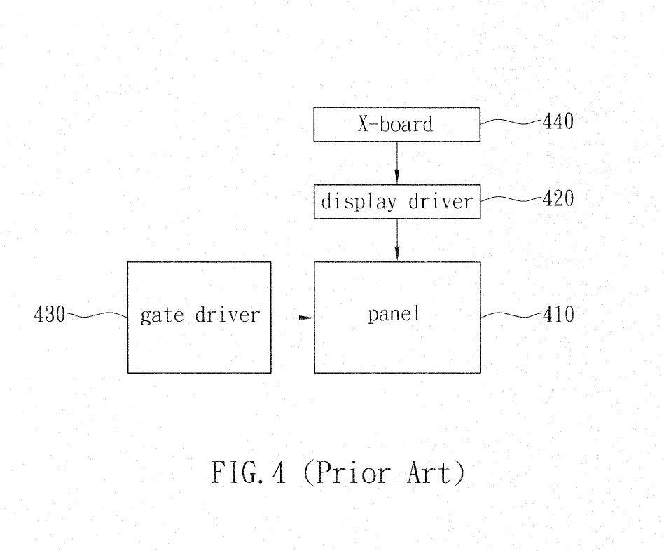

### DETAILED DESCRIPTION OF THE PREFERRED EMBODIMENT

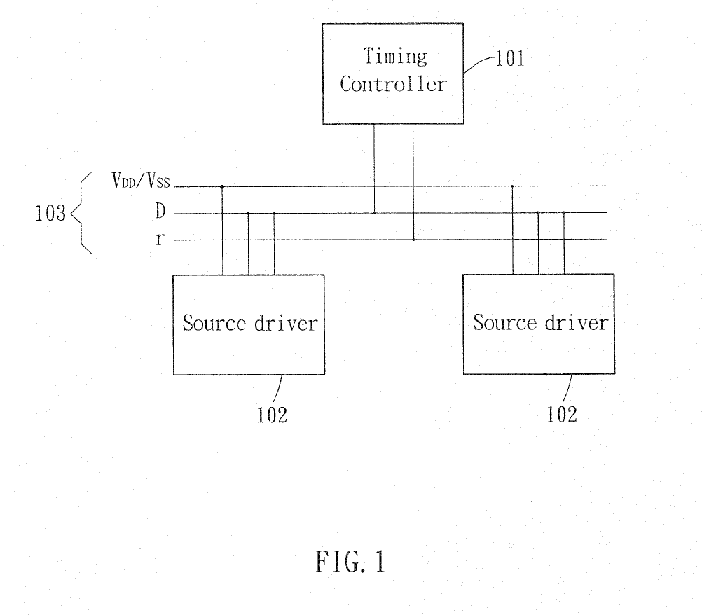

Referring to FIG. 1, it is a block diagram of a driving system for display according to an embodiment of the present invention. The driving system includes a timing controller 101, source drivers 102, and a bus 103 connected between the timing controller 101 and the source drivers 102. The bus 103 carries power VDD/VSS, data signals D, and gamma reference signals r. The timing controller 101 outputs the data signals D and the gamma reference signals r to the source drivers 102 via the bus 103. The source drivers 102 receive the gamma reference signals r for decoding the data signals D into analog driving voltages. The gamma reference signals r are digital and may be sent sequentially such that the number of bus lines can be reduced compared to that of the conventional art.

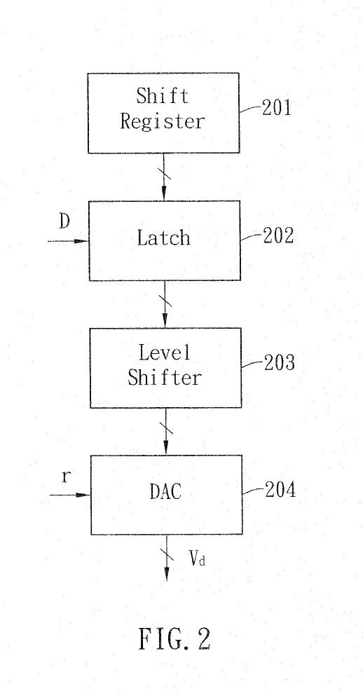

Referring to FIG. 2, it is a block diagram of the source driver, including a shift register 201, a latche 202, a level shifter 203, and a digital to analog converter (DAC) 204. The latch 202 includes multiple memory units. The shift register 201 sends a control signal to enable each of the memory units to store data signals D. The level shifter 203 adjusts the voltage level of the data signals D coming from the latch 202.

The DAC 204 receives the gamma reference signals r to decode the data signals D, from the level shifter 203, into analog driving voltages.

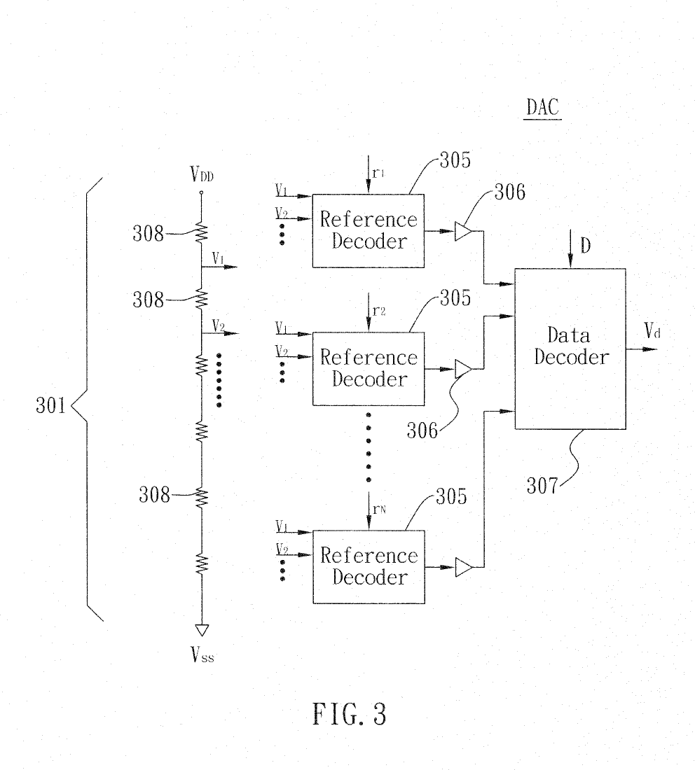

Referring to FIG. 3, it is a block diagram of the DAC. The DAC 204 includes a reference voltage generator 301, reference decoders 305, buffers 306 and a data decoder 307. The reference voltage generator 301 includes a resistor string connected between a high voltage source VDD and a low voltage source VSS, and the resistor string comprises multiple resistors 308 in serial to generate multiple reference voltages V1-Vn to the reference decoders 305.

The reference decoders 305 are programmable and controlled by the gamma reference signals r, which includes gamma reference signals r1-rn sequentially sent from the timing controller 101. Each of the reference decoders 305 selects a voltage from the resistor string, based on the corresponding gamma reference signal r, as a gamma reference voltage Vr and outputs the generated reference voltage Vr to the corresponding unit gain buffers 306.

The data decoder 310 selects a voltage from gamma reference voltages Vr1-Vrn as a driving voltage Vd by decoding the data signals D.

One skilled in the art will understand that the embodiment of the present invention as shown in the drawings and described above is exemplary only and not intended to be limiting.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A display driver comprising:
a digital-to-analog converter for receiving a plurality of gamma reference signals, comprising:
a reference voltage generator for generating a plurality of reference voltages;
a plurality of reference decoders, each receiving corresponding one gamma reference signal and selectively outputting a gamma reference voltage from said reference voltages based on the corresponding gamma reference signal; and
a data decoder receiving the gamma reference voltages for selectively outputting an analog voltage based on a data signal.

2. The display driver according to the claim 1, wherein the digital-to-analog converter further comprises a plurality of buffers, each connected between the corresponding reference decoder and the data decoder.

3. The display driver according to the claim 1, wherein the reference voltage generator comprises a plurality of resistors in serial.

4. The display driver according to the claim 1, wherein the gamma reference signals are digital.

5. The display driver according to the claim 1, wherein the gamma reference signals are received in sequence.

6. The display driver according to the claim 5, wherein the gamma reference signals are received in sequence via a single-line bus.

7. A display comprising:
a timing controller for outputting a plurality of data signals and gamma reference signals; and
a display driver comprising:
a plurality of digital-to-analog converters, each receiving the gamma reference signals for generating analog gamma reference voltages and receiving one of the data signals for selectively outputting a driving voltage from the gamma reference voltages.

8. The display according to claim 7, wherein each of the digital-to-analog converters comprises:
a reference voltage generator for generating a plurality of reference voltages;
a plurality of reference decoders, each receiving corresponding one gamma reference signal and selectively outputting a gamma reference voltage from said reference voltages based on the corresponding gamma reference signal; and
a data decoder receiving the gamma reference voltages for selectively outputting an analog voltage based on one of the data signals.

9. The display according to the claim 7, wherein the gamma reference signals are digital.

10. The display according to the claim 7, wherein the gamma reference signals are received in sequence.

11. The display according to the claim 10, wherein the gamma reference signals are received in sequence via a single-line bus.

12. A digital to analog converting method comprising:
receiving gamma reference signals and a data signal, wherein the reference signals and the data signal are in digital format;
generating gamma reference voltages based on the reference signals; and
selectively outputting an driving voltage from the reference voltages by decoding the data signal.

13. The digital to analog converting method according to claim 12, wherein a plurality of selection voltages are selected by decoding the reference signals to form one of the reference voltages.

14. The digital to analog converting method according to claim 12, wherein the selection voltages are provided by a plurality of resistors in serial.
